(19) United States
(12) Patent Application Publication
(10) Pub. No.: US 2026/0139864 A1
(43) Pub. Date: May 21, 2026

(54) ORDERING A CHILLER SYSTEM BASED ON ENVIRONMENTAL CONDITIONS AND PERFORMANCE COEFFICIENTS

(71) Applicant: TRANE INTERNATIONAL INC., Davidson, NC (US)

(72) Inventors: Dan J. Berg, Lakeville, MN (US); Anthony W. Bruno, Blaine, MN (US); Chuck Patrick Lehn, Albertville, MN (US); Brian A. Kirkman, Shoreview, MN (US); Krista Hubbs, Davidson, NC (US)

(21) Appl. No.: 18/952,594

(22) Filed: Nov. 19, 2024

(51) Int. Cl. F24F 11/63; F24F 110/12; F24F 110/52

(52) U.S. Cl. CPC F24F 11/63; F24F 2110/12; F24F 2110/52

(57) ABSTRACT

The ordering or staging of packaged units corresponding to an array thereof includes detecting environmental conditions proximate to the array, selecting a calculation for ordering the packaged units based on at least one of the detected environmental conditions, executing the selected calculation for each of the packaged units included in the array, and ranking the respective packaged units based on respective results of the executed calculation. The selected calculation for each of the respective packaged units factors an operational coefficient, a weighted value of a detected runtime, and at least one of a detected intake air temperature or a detected wind speed

### FIELD

This disclosure relates generally to a heating, ventilation, air conditioning, and refrigeration (HVACR) system having an array of packaged units to condition a space. More specifically, the disclosure relates to controls and methods for ordering or rendering more efficient operation of the packaged units of the array thereof to, e.g., reduce energy consumption of the array in conditioning the space.

### BACKGROUND

A heating, ventilation, air conditioning, and refrigeration (HVACR) system may include an array of installed rooftop units that may include one or more heat exchangers to facilitate thermal energy exchange between a heat transfer fluid and the outdoor air. The heat transfer fluid may be part of a fluid circuit to condition indoor air. A fan may move the conditioned indoor air in an air distribution system to condition the entire building, e.g., a data center with dozens, hundreds, or even thousands of servers and/or processors. Operation of even a portion of the array of rooftop units may change the environmental conditions surrounding the array, including a temperature profile of the outdoor air over the array. For example, when the rooftop units release heat into outdoor air, i.e., ambient, upstream rooftop units in the group may exhaust heat into the outdoor air, thus increasing the intake temperature of a downstream rooftop unit in the same array, thereby decreasing operating efficiency of the downstream rooftop unit.

### SUMMARY

This disclosure relates generally to a heating, ventilation, air conditioning, and refrigeration (HVACR) system having an array of packaged units, e.g., air-cooled chillers, direct free cooling chillers, air handling units, air conditioning outdoor units, heat pumps, air-cooled condensers or coils, and the like, to condition a space. More specifically, the disclosure relates to methods, programs, and/or apparatuses designed, programmed, or otherwise configured to order and/or prioritize operation of one or more packaged units within the array to improve performance and efficiency thereof, based on any one or more of environmental variables and/or performance operational variables.

In accordance with at least one non-limiting example embodiment, as described and recited herein, a computer-readable medium has executable instructions stored thereon. When executed, the instructions cause one or more processors to control respective packaged units from an array thereof by detecting environmental conditions proximate to the array, selecting a calculation for ordering the packaged units based on at least one of the detected environmental conditions, executing the selected calculation for each of the packaged units included in the array, and ranking the respective packaged units based on respective results of the executed calculation. The selected calculation for each of the respective packaged units factors an operational coefficient, a weighted value of a detected runtime, and at least one of a detected intake air temperature or a detected wind speed.

In accordance with at least one non-limiting example embodiment, as described and recited herein, a controller method of operating an array of packaged units corresponding to a heating, ventilation, air conditioning, and refrigeration (HVACR) system includes detecting at least two current environmental conditions for the array of packaged units; determining a calculation to be used to order the packaged units, respectively, relative to one another based on the determined current environmental conditions; detecting an air temperature at each of the respective packaged units; detecting at least a wind speed; detecting a runtime for each of the respective packaged units; and calculating, using the determined calculation, an operational coefficient for each of the respective packaged units based on, for each of the respective packaged units, a weighted value of the detected runtime and at least one of the detected air temperature or detected wind speed.

### DRAWINGS

FIG. 1 shows a schematic of a refrigeration circuit, implemented in an HVACR system, in accordance with at least some of the non-limiting example embodiments described and recited herein.

FIG. 2 shows a schematic view of a non-limiting example of a packaged unit, in accordance with at least some embodiments described and recited herein.

FIG. 3A is a perspective view of a non-limiting example of an array of packaged units, in accordance with at least some embodiments described and recited herein.

FIG. 3B is a top view of a portion of the example array of FIG. 3A, in accordance with at least some embodiments described and recited herein.

FIG. 4 is a non-limiting example of a processing flow for ordering an array of packaged units based on environmental conditions and performance, in accordance with at least some embodiments described and recited herein.

FIG. 5 is an illustrative computing embodiment, in which any of the controlling functionalities may be implemented, in accordance with at least some embodiments described and recited herein.

### DETAILED DESCRIPTION

As a non-limiting example setting, data centers often have high quantities of air-cooled equipment, e.g., chillers, applied for cooling of the data center server equipment. In this example setting, an array of multiple chillers may be arranged on a roof or open area in a high-density layout. Wind, air temperature as it enters a coil, and chiller performance are non-exclusive factors in staging chiller performance order. This disclosure is directed to determination, implementation, and/or facilitation of logic to factor in these variables.

For example, data centers have had critical failures due to excessive heat caused by ambient air temperatures and chiller performance/service-related issues. The solutions described and/or recited herein provide a calculation and/or determination of which chillers from such array are suited to run at a certain time based on these variables, and thus provides a further calculation and/or determination of an overall staging sequence order.

Furthermore, in response to yet another concern, the solutions described and/or recited herein are applicable for when an array of chillers has been running for an extended period of time, and the chillers are operating with performance related issues and/or dirty heat exchanger coils. The solutions implement a rotation to operate different chillers that, e.g., have been running for a shorter period of time or have been idle, have shown more efficient performance over the extended period of time, have cleaner coils, etc. Accordingly, the solutions described and recited herein facilitate improved operational efficiency, site load capacity control, and chiller operation, to optimally meet site load requirements to help to ensure plant operation and reliability.

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a substantive explanation of the current example embodiment. Still, the example embodiments described in the detailed description, drawings, and claims are not intended to be limiting. Other embodiments may be utilized, and other changes may be made, without departing from the spirit or scope of the subject matter presented herein. It will be readily understood that the aspects of the present disclosure, as generally described and recited herein, as well as illustrated in the drawings, may be arranged, substituted, combined, separated, and designed in a wide variety of different configurations, all of which are explicitly contemplated herein.

Additionally, portions of the present disclosure may be described herein in terms of functional block components and various/or processing operations. It should be appreciated that such functional blocks may be realized by any number of hardware and/or software components configured to perform the specified functions.

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not intended to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

Additionally, the present disclosure may be described herein in terms of functional block components and various processing steps. It should be appreciated that such functional blocks may be realized by any number of hardware and/or software components configured to perform the specified functions.

The scope of the disclosure should be determined by the appended claims and their legal equivalents, rather than by the examples given herein. For example, the operations recited in any method claims may be executed in any order; that is, they are not limited to the order presented in the claims. Moreover, no element is essential to the practice of the disclosure unless specifically described herein as “critical” or “essential.”

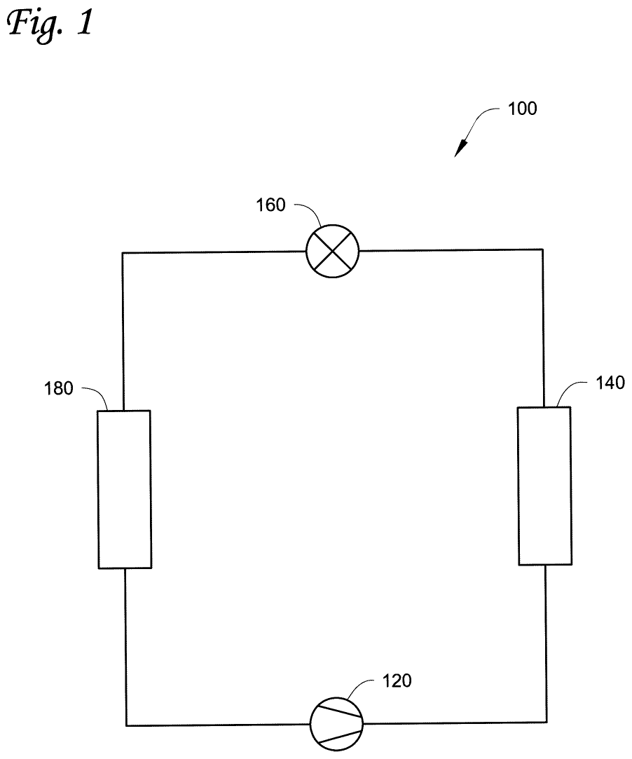

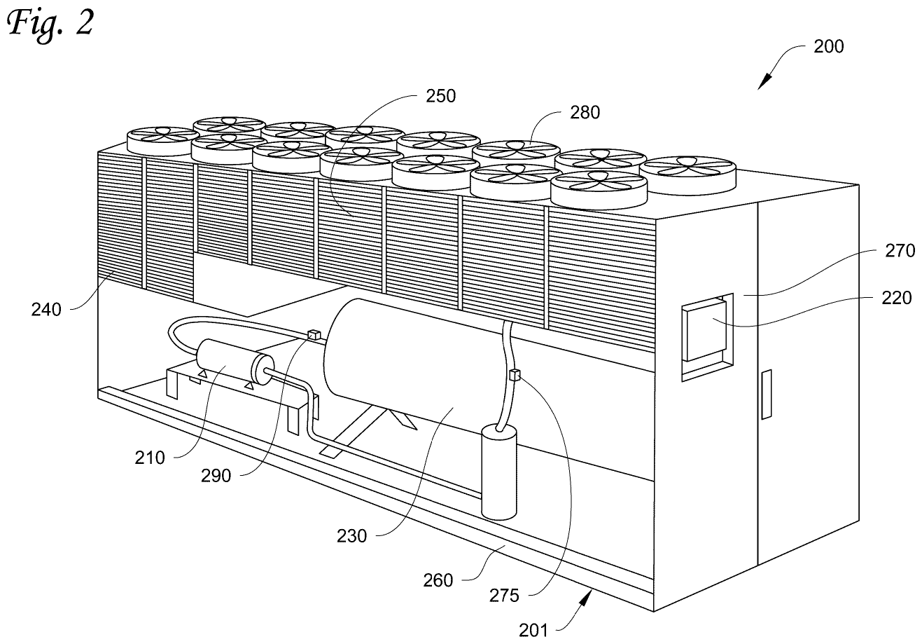

FIG. 1 is a schematic diagram of a refrigerant circuit 100, according to at least one non-limiting example embodiment as described and recited herein. The refrigerant circuit 100 may be, e.g., one of multiple packaged units such as a chiller, that is included in an array, subject to the description and recitation herein. Each of refrigerant circuits 100 may include compressor 120, condenser 140, expander 160, and evaporator 180. Refrigerant circuit 100 may also include controller, (see FIG. 2; e.g., controller 220) that is designed, programmed, or otherwise configured to control operation of one or more of compressor 120, condenser 140, expander 160, and/or evaporator 180.

Refrigerant circuit 100 may generally be applied in a variety of systems used to control an environmental condition, e.g., temperature, humidity, air quality, etc., in a conditioned space. The conditioned space may be a space within a server farm, i.e., a data center, an office building, a commercial building, a factory, a laboratory, a residential building, or the like. In at least one example embodiment, refrigerant circuit 100 may be configured to be a cooling system, e.g., an air conditioning system, to operate in a cooling mode; and/or refrigerant circuit 100 may be configured to be a heat pump to operate in a heating/defrost mode. Refrigerant circuit 100 may be configured to operate in a cooling mode and a heating/defrosting mode.

Compressor 120, condenser 140, expander 160, and evaporator 180 may be fluidly connected. An “expander,” as described and/or recited herein, may refer to as an expansion device, including but not limited to an expansion valve, expansion plate, expansion vessel, orifice, or the like, or other such types of expansion mechanisms. That is, expander 160 may be any suitable type of expander used in the field for expanding a working fluid to cause the working fluid to decrease in pressure and temperature.

Refrigerant circuit 100 may operate according to generally known principles, meaning refrigerant circuit 100 may be configured to heat and/or cool a liquid process fluid. The liquid process fluid may be a heat transfer fluid or medium, e.g., liquid including, but not limited to, water, glycol, mixtures thereof, and the like, etc.

In accordance with the non-limiting example embodiments described and recited herein, refrigerant circuit 100 may be a liquid chiller system. In addition, or in the alternative, refrigerant circuit 100 may be configured to heat and/or cool a gaseous process fluid, e.g., a heat transfer medium or fluid such as a gas, in which case the refrigerant circuit 100 may be generally representative of an air conditioner and/or heat pump.

In accordance with at least some non-limiting alternative embodiments, refrigerant circuit 100 may be configured to operate as a vapor-compression circuit by which compressor 120 compresses a working fluid, e.g., a heat transfer fluid, from a relatively lower pressure gas to a relatively higher-pressure gas. The relatively higher-pressure gas is at a relatively higher temperature, being discharged from compressor 120 and flowing through condenser 140. In accordance with generally known principles, the working fluid flows through condenser 140 and rejects heat to the process fluid, e.g., water, air, etc., thereby cooling the working fluid. The cooled working fluid, which is now in a liquid form, flows to expander 160 that may reduce the pressure of the working fluid. As a result, a portion of the working fluid is converted to a gaseous form. The working fluid, which is now in a mixed liquid and gaseous form flows to evaporator 180. The working fluid flows through evaporator 180 and absorbs heat from the process fluid, e.g., a heat transfer medium such as, but not limited to, water, a solution, air, etc., heating the working fluid, and converting it to a gaseous form. The gaseous working fluid then returns to compressor 120. The above-described process continues while the heat transfer circuit is operating, for example, in a cooling mode, e.g., while compressor 120 is enabled.

In some embodiments, refrigerant circuit 100 may be configured to operate as a free cooling/heating circuit to control one or more environmental conditions of the conditioned space. A free cooling/heating circuit may include a first heat exchanger and a second heat exchanger fluidly connected by a working fluid. The first and second heat exchangers of the free cooling/heating circuit may be dedicated heat exchangers in addition to the refrigeration circuit 100 having compressor 120, condenser 140, expander 160, and evaporator 180. In some embodiments, the first and second heat exchangers may share, for example, condenser 140 and evaporator 180 such that refrigeration circuit 100 may operate as a free cooling/heating circuit or a vapor compression circuit.

In some embodiments, the first heat exchanger may exchange thermal energy between a working fluid and an ambient fluid, e.g., outdoor air. The first exchanger may be disposed in a location suitable to exchange thermal energy with the ambient fluid. The location may include a rooftop of the conditioned space. The second heat exchanger may be evaporator 180 to exchange thermal energy between the working fluid and fluid in the conditioned space. Fluid in the conditioned space can, for example, be indoor air. In some embodiments, the first heat exchanger may be condenser 140.

In a cooling operation, the first heat exchanger may release thermal energy to the ambient fluid and cool the working fluid. A pump may move the cooled working fluid to the second heat exchanger to exchange thermal energy with the fluid in the conditioned space, heating the working fluid to be cooled by the ambient fluid again. In some embodiments, in a cooling operation, the ambient fluid may have a temperature lower than the temperature of the fluid in the conditioned space. In a heating operation, the pump may circulate the working fluid between the first and the second heat exchangers to move thermal energy from the ambient fluid to the fluid in the conditioned space. In some embodiments, in a heating operation, the ambient fluid may have a temperature higher than the temperature of the fluid in the conditioned space. The working fluid may be any heat transfer fluid such as a refrigerant, water, a water solution, glycol fluid, and the like, etc.

FIG. 2 is a schematic view of a packaged unit 200, in accordance with at least some of the non-limiting example embodiments described and/or recited herein. Packaged unit 200 may be any piece of HVACR equipment that exchanges thermal energy with the environment by, for example, absorbing or releasing thermal energy with an ambient fluid, e.g., outdoor air. Packaged unit 200 may include at least a portion of a fluid circuit to transfer thermal energy therefrom to the conditioned space. In some embodiments, the fluid circuit may be a heat transfer circuit, (see, e.g., FIG. 1) that is configured to be a free cooling/heating circuit, a vapor-compression circuit, or the like, or a combination thereof.

In at least one non-limiting example embodiment, packaged unit 200 may be an air-cooled chiller, a free cooling chiller, e.g., a direct free cooling chiller, an air handling unit, an air conditioning outdoor unit, a heat pump, an air-cooled condenser or coil, and the like, etc.

As an air-cooled chiller, packaged unit 200 may have at least one heat exchanger disposed therein that facilitates heat exchanging between air and a fluid circuit. The circuit may be a free heating/cooling circuit or a vapor-compression circuit to provide environmental control to a controlled space. In at least some non-limiting example embodiments, the air-cooled chiller may include a free cooling circuit configured to cool the condenser in a vapor-compression circuit. The free cooling circuit may include a liquid-air heat exchanger to cool the condenser.

The air handling unit may include a fan or blower to move conditioned air through an air distribution system to condition the conditioned space. The air handling unit may include an air outlet that may release air into the environment. For example, the air outlet may be an outlet of a heat exchanger configured to condense a working fluid, releasing an exhaust that is heated above the ambient temperature.

The air conditioning outdoor unit may include a condenser configured to condense a refrigerant in a fluid circuit. A fan of the air conditioning outdoor unit may force the ambient fluid, such as outdoor air, through the condenser to remove thermal energy from the condenser. The air conditioning outdoor unit may be fluidly connected with an evaporator, an expander, and a compressor to form the fluid circuit. The fluid circuit may include a vapor-compression circuit. It is appreciated that the evaporator, the expander, and/or the compressor may or may not be contained within the same housing of the air conditioning outdoor unit. In some embodiments, the heat pump may include an evaporator configured to evaporate a refrigerant fluidly connecting a condenser, a compressor, and an expander with the evaporator in a refrigeration circuit.

The heat pump may include an evaporator configured to evaporate a refrigerant in a fluid circuit. A fan of the heat pump may force ambient fluid, such as outdoor air, through the evaporator to provide thermal energy to evaporate the refrigerant. The heat pump may be fluidly connected with a condenser, an expander, and a compressor to form the fluid circuit. The fluid circuit may include a vapor-compression circuit. It is appreciated that the condenser, the expander, and/or the compressor may or may not be contained within the same housing of the heat pump.

Packaged unit 200 may include housing (or enclosure) 201 configured to contain one or more HVACR system equipment, such as compressor 120, condenser 140, expander 160, and evaporator 180 of refrigeration circuit 100 of FIG. 1.

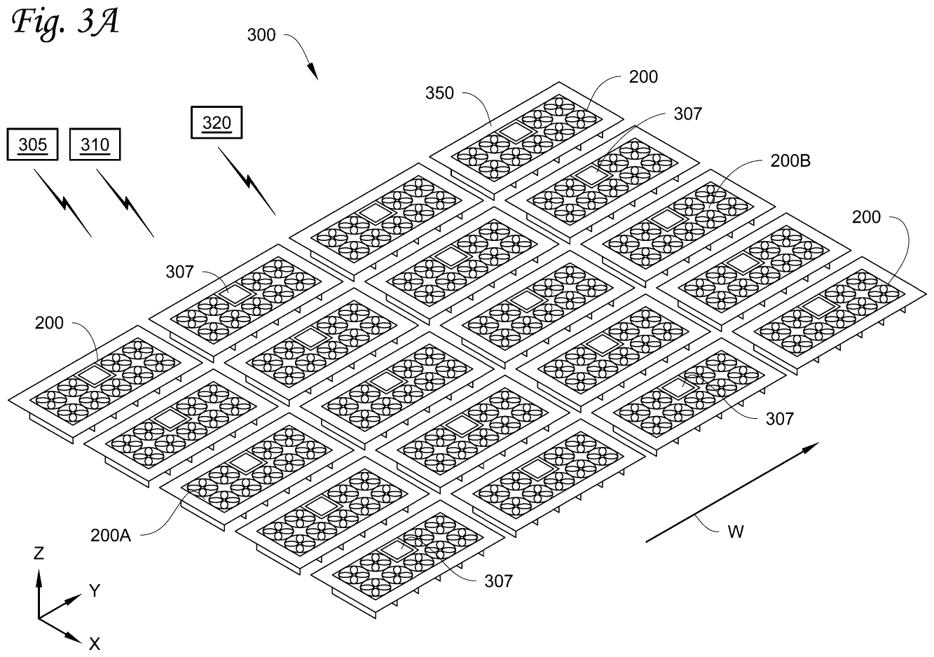

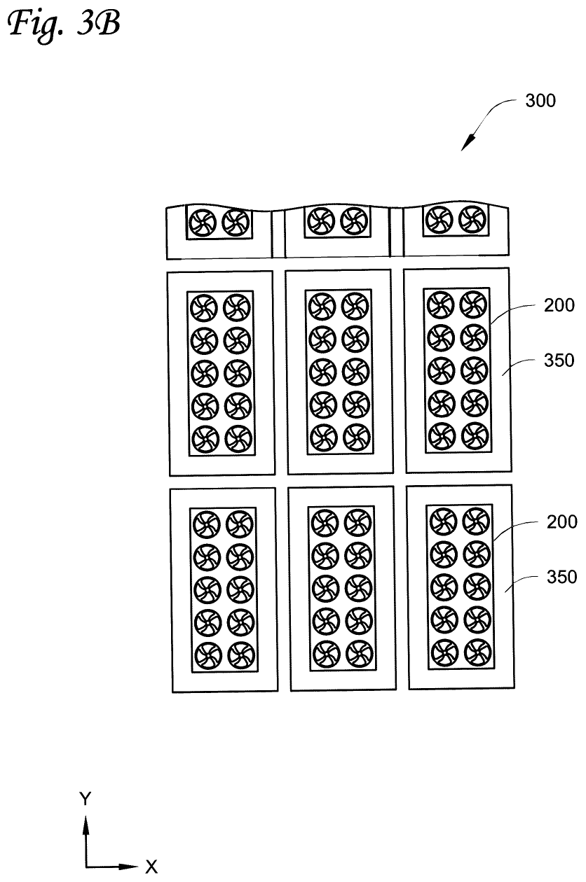

As shown in FIG. 2, housing 201 of packaged unit 200 may include compressor 210, evaporator 230, condenser 240, packaged unit controller 220, and one or more panels 270. Controller 220 may be designed, programmed, and/or configured to control packaged unit 200 in accordance with instructions from array controller 320, shown and described with reference to FIG. 3A. Condenser 240 is connected to air coil 250 and one or more fans 280. In at least one non-limiting example embodiment, compressor 210 may be a fixed speed or variable speed compressor to compress a working fluid. Fans 280 may be single speed or variable speed and/or fans with a multiple number of fan stages or discrete steps to move air, for example, through air coil 250. Panels 270 may be removable to provide access to housing 201.

Housing 201 may further include one or more of transducer 290 located along condenser 240 and/or transducer 275 located along evaporator 180 to detect and/or measure a pressure and temperature of the refrigerant flowing therethrough. Thus, one or both of transducer 275 or transducer 290 may transmit to packaged unit controller 220 and/or array controller 320 a temperature of the refrigerant and a discharge pressure.

Packaged unit 200 may be considered as a single unit within the HVAC system and be supported by frame 260.

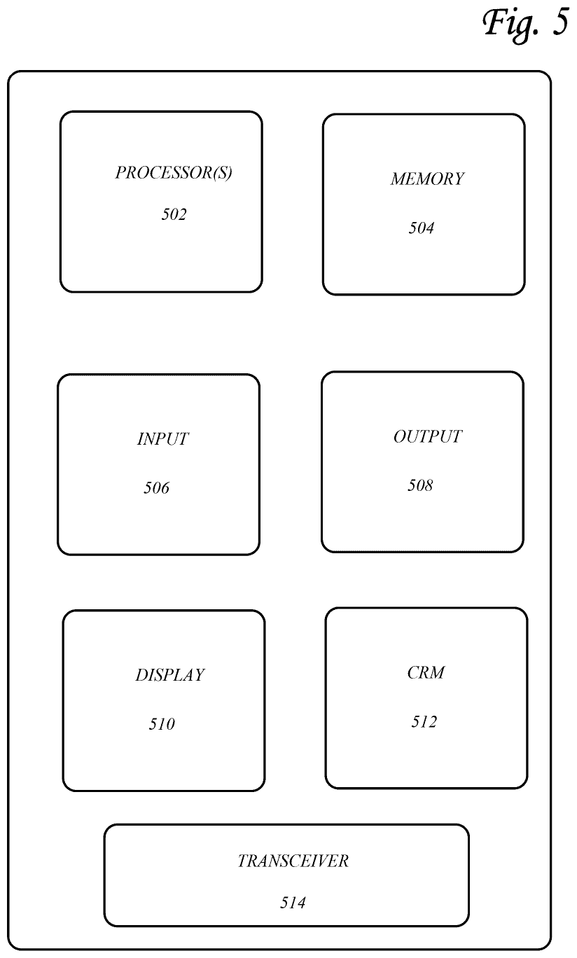

Both packaged unit controller 220 and array controller 320 may, respectively, include at least a processor and memory, an input/output (I/O) interface (see FIG. 5). Controller 220 may be designed, programmed, and/or configured to receive data as input from various components within the HVACR system, such as the components shown in FIG. 1 and FIG. 2, to thereby facilitate control of the operation of multiple packaged units 200.

FIG. 3A is a perspective view of a non-limiting example of an array 300 of packaged units, and FIG. 3B is a top view of a portion of the example array of FIG. 3A, both in accordance with at least some embodiments described and recited herein.

Referencing at least some features shown in FIGS. 3A and 3B, array controller 320 may be designed, programmed, and/or configured to receive, from temperature sensor 305, a current ambient temperature near and/or surrounding array 300; and, array controller 320 may also be designed, programmed, and/or configured to receive, from wind sensor 310, a current wind speed and direction near and/or surrounding array 300 as representative of a facility wind condition, as follows.

Array controller 320 may be a central controller in communication with packaged units 200 in array 300 utilizing any suitable communications including power line communications, Pulse Width Modulation (PWM) communications, Local Interconnect Network (LIN) communications, Controller Area Network (CAN) communications, and the like, etc. The communications may include wired and/or wireless, analog and/or digital communications. In at least one embodiment, the communication may include communications over telematics.

In accordance with one or more non-limiting example embodiments, one or more temperature sensors 305 may be uniformly disposed around array 300, and, to determine or measure the facility ambient temperature, array controller 320 may calculate an average of the received temperatures from the respective temperature sensors 305, calculate a mean of the received temperatures, and/or regard the lowest received temperature to be the ambient temperature, etc. Regardless of how a current facility ambient temperature for array 300 is determined and/or measured by array controller 320 when multiple temperature sensors 305 are disposed around array 300, array controller 320 utilizes a singular current temperature as a factor to determine a methodology to order and/or stage operation of packaged units 200 in array 300. That is, for the embodiments described and recited herein, the determined or measured facility ambient temperature is at least one basis for determining which environmental- and/or performance-based metrics are factored in to determine and/or compute a staging performance coefficient, as described further below.

Ambient temperature sensor 305 may refer to a thermistor, thermocouple, thermometer, or other thermal sensing element or component, analog or, typically, digital, that is not physically attached to any of packaged units 200 and is configured to determine a current ambient temperature near and/or surrounding array 300. Thus, ambient temperature sensor 305, as depicted in FIG. 3A may be representative of multiple thermometers that are positioned near or around array 300, so as to transmit, via wired or wireless communication protocol, respective current temperature readings to array controller 320.

Also, in accordance with one or more non-limiting example embodiments, one or more array wind sensors 310 may be uniformly disposed around array 300, and, to determine or measure wind speed at or surrounding the, array controller 320 may calculate an average of the received wind speed from the respective array wind sensors 310, calculate a mean of the received wind speeds, and/or regard the highest received wind speed to be the ambient wind speed, etc. Regardless of how a current facility ambient wind speed for array 300 is determined and/or measured by array controller 320 when multiple array wind sensors 310 are disposed around array 300, array controller 320 utilizes a singular current wind speed as a factor to determine a methodology to order and/or stage operation of packaged units 200 in array 300. That is, for the embodiments described and recited herein, the determined or measured facility wind speed is at least one basis for determining which environmental- and/or performance-based metrics are factored in to determine and/or compute a staging performance coefficient, as described further below.

Array wind sensor 310 may refer to a wind sensor that is not physically attached to any of packaged units 200 and is configured to determine a current wind speed and direction near and/or surrounding array 300. Thus, array wind sensor 310, as depicted in FIG. 3A may be representative of multiple wind sensors that are positioned near or around array 300 to transmit, via wired or wireless communication protocol, respective wind speed and direction measurements to array controller 320.

Array controller 320 may also be designed, programmed, and/or configured to receive from each entering air sensor 307, of which each of the respective packaged units 200 has at least one, a current temperature and/or speed of air entering the respective packaged unit 200. Array controller 320 is thus further designed, programmed, and/or configured to rank order all packaged units 220 corresponding to array 300 based on the current temperature or speed of the air entering each packaged unit 220. In accordance with at least some of the embodiments described and/or recited herein, with X being the number of packaged units 200 in array 300, array controller 320 rank orders the packaged units from 1 to X, with 1 corresponding to the packaged unit 200 having the lowest current temperature, and X corresponding to the packaged unit 200 having the highest current temperature. The ranking is implemented accordingly since a low temperature for an operating packaged unit is conducive to more efficient operation thereof.

Array controller 320 may be designed, programmed, and/or configured to receive, from the one or more array wind sensors 310, a current wind speed and direction near and/or surrounding array 300. Accordingly, array controller 320 may receive a current ambient wind speed and direction from array wind sensor 310 to serve as a factor on which a staging order for packaged units 200, e.g., chillers, corresponding to a common array 300 may be based.

That is, as a non-limiting example, array controller 320 may be further configured to receive the current wind speed and direction from array wind sensor 310, through either of a wired or wireless communication protocol, and to then divide the overall possible wind direction into degrees of azimuth using 0-360 for the overall range. The overall span of azimuth may then be divided into eight (8) sections representing one of the following directions indicated in Table 1, below, with degrees of azimuth defined for each of the ranges. A multistate value, i.e., wind directional coefficient, may then be created representing the eight (8) possible directional states and ranges, as shown in non-limiting example Table 2, below. That is, array controller 320 may be further configured to calculate the specific directional segment based on degrees azimuth.

TABLE 2

| Wind Direction | Point Value | Range of Azimuth Degrees |
|---|---|---|
| North | 1 | 337.6-360 and 0-22.5 |
| Northeast | 2 | 22.6-67.5 |
| East | 3 | 67.6-112.5 |
| Southeast | 4 | 112.6-157.5 |
| South | 5 | 157.6-202.5 |
| Southwest | 6 | 202.6-247.5 |
| West | 7 | 247.6-292.5 |
| Northwest | 8 | 292.6-337.5 |

Table 2 provides examples of multistate point values, i.e., coefficient, and degree ranges, representing degrees azimuth, that may be factored by array controller 320 to determine or calculate a staging order for packaged units 200 corresponding to array 300, in accordance with at least one non-limiting example embodiment. That is, the determined or measured wind speed and direction at each of packaged units 200 corresponding to array 300 is a basis for determining a staging performance coefficient, as described further below.

In FIG. 3A, each packaged unit 200 has a temperature sensor 307.

In accordance with the non-limiting example embodiments described and/or recited herein, packaged unit controller 220 or array controller 320 may be further designed, programmed, and/or configured to determine and/or record a current operational time, current idle time, and/or past operational times, e.g., run time, for the respective packaged unit from the connected machine/chiller commands, running state/status and components, and records data as controlled/commanded/sensed for unit, compressor, circuit, runtime, starts etc. It may also be a function of recorded data from controller 320 at the system level. The operational time may be determined and/or recorded in various manners, none of which is exclusive to the embodiments described and/or recited herein. Thus, operational time may be determined and/or recorded with regard to time stamps of start and stop times, a measurement of time of current operation, a measurement of a determined or even undetermined number of previous operational times, etc. Regardless of how operational time, e.g., run time, is determined and/or recorded by either of packaged unit controller 220 or array controller 320, for the embodiments described and/or recited herein, array controller 320 utilizes a consistent methodology for determination and/or recordation thereof for each packaged unit 200 corresponding to array 300 to order and/or control packaged units 200 in array 300.

Array controller 320, or one of controllers 220 in the example embodiment in which operational time is determined and/or recorded by a respective controller for each of packaged units 200, rank orders each of the packaged units 220 corresponding to a common array 300 based on the current and/or recorded operational time for each packaged unit 220. In accordance with at least some of the embodiments described and/or recited herein, with X being the number of packaged units 200 in the common array 300, array controller 320 rank orders the packaged units from 1 to X, with 1 corresponding to the packaged unit 200 having the lowest current operational time or having the longest current idle time, and X corresponding to the packaged unit 200 having the highest current run time or having the shortest current idle time. The ranking is afforded accordingly since a low temperature for an operating packaged unit is conducive to more efficient operation thereof.

In accordance with the non-limiting example embodiments described and/or recited herein, array controller 320 is further designed, programmed, and/or configured to receive data from various sensors disposed throughout each of individual packaged units 200 and then determine, for each packaged unit, e.g., chiller, a performance ranking utilized for operational staging. Array controller 320 may be designed, programmed, and/or configured to calculate the performance coefficient values based on diagnostic conditions including, a disparity or difference between ambient temperature, relative to a respective one of packaged units 200, and a saturated refrigerant temperature for that packaged unit, as indicated by one or more of transducer 275 and transducer 290 of the packaged unit 200.

Thus, array controller 320 is designed, programmed, and/or configured to determine another performance ranking based on, in part, a known or predetermined refrigerant pressure temperature curve for packaged unit 200, indicative of optimal performance. Therefore, as a non-limiting example, if a transducer 275 transmits to controller 220 a detected refrigerant temperature of 140° F., and ambient temperature sensor 305 (see FIG. 3A) transmits to controller 220 an ambient temperature of 100° F., the difference of 40° F. is measured against the known curve. Continuing with the non-limiting example, a difference of 40° F. may be indicative of coils 250 that are underperforming due to, e.g., dirt, rust, age, and the like, etc., thus causing array controller 320 from each of packaged unit controllers 220 to assign a high-performance coefficient for the respective packaged unit 200. Performance of condenser 240 of the respective packaged units 200 is ranked accordingly.

In addition, transducers 290 are disposed along evaporator 180 to detect or measure a saturated temperature of evaporator 180 as vapor evaporates before being pulled back to compressor 120 as well as a temperature of water as it exits the evaporator. Therefore, as a non-limiting example, if a transducer 290 transmits to controller 220 a detected saturated temperature of 40° F., and another transducer 290 transmits to controller 220 a temperature of 44° F. for the temperature of water or coolant as it exits evaporator 180, the difference of 4° F., which is measured against the known curve. Continuing with the non-limiting example, a difference of 4° F. may be acceptable, with higher values corresponding to underperforming coils/exchangers 230, thus causing array controller 320 to assign a high-performance coefficient for the respective packaged unit 200. Performance of the evaporator 180 of the respective packaged units 200 is ranked accordingly.

In accordance with the non-limiting example embodiments described and/or recited herein, array controller 320 is further designed, programmed, and/or configured to rank sort each of the packaged units 200 corresponding to a common array 300 based on a summation of the performance rankings of the respective condensers 240 and evaporators 180 corresponding to each of the packaged units 200. This summation of the rankings is utilized to determine an overall performance coefficient, as described further below, by which staging of the packaged units is implemented.

In FIGS. 3A and 3B, array 300 may include one or more packaged units 200 arranged in a pattern. As illustrated, array 300 may include twenty packaged units 200 arranged in a pattern of a 4×5 rectangular grid. Packaged units 200 may be arranged in any suitable pattern as, for example, but not limited to, a grid, a circle, irregular, or a combination thereof. The size of array 300 may include any number of the same or different packaged units 200. For example, packaged units 200 of array 300 may each have a full operating load of a first heating or cooling capacity. A full operating load may be the maximum output of packaged unit 200 as designed by the manufacturer of packaged unit 200. In some non-limiting example embodiments, some of packaged units 200 of array 300 may have a full operating load larger, equal to, or smaller than the first heating or cooling capacity. In some embodiments, one or more packaged units 200 may operate in full or partial load of the full operating load. Operating under a partial load may be caused by controller 220 or inefficiencies due to, for example, ambient temperature being outside a temperature range most efficient for the packaged unit.

Array 300 of packaged units 200 may provide a conditioning load larger than a single packaged unit 200, for example, for a conditioned space that requires a larger conditioning load.

The exhaust of one or more packaged units 200 in array 300 may affect the operating condition of one or more other packaged units 200 in array 300. In some embodiments, the ambient fluid may flow in direction W. The ambient fluid may be outdoor air flowed by the wind. Affecting the operating condition may include, for example, increasing or reducing an ambient temperature above or below a temperature range efficient for packaged units 200.

Upstream units 200A and downstream units 200B may include one or more packaged units 200 disposed relative to the wind direction W. Upstream units 200A may create an exhaust that affect the ambient fluid. The exhaust may affect the ambient fluid, for example, by changing the ambient temperature of the ambient fluid at some locations over array 300. For example, in a cooling mode, upstream units 200A may create an exhaust that heats the ambient fluid at a location over downstream units 200B. Downstream units 200B may receive the ambient fluid heated by upstream units 200A. As a result, downstream units 200B may operate at a lowered efficiency or lowered capacity because of the ambient temperature of the ambient fluid provided to downstream units 200B are outside the temperature range of which packaged units 200 may operate most efficiently.

One or more of packaged units 200 may optionally include separator 350. In at least one non-limiting example embodiment, separator 350 may be a baffle, a plate, or the like. Separator 350 may be configured to eliminate or reduce hot/cold discharge air recirculation of packaged unit 200, e.g., at the chiller coil air inlet surfaces, into the chiller coil inlets, and the like, etc.

Regarding the embodiments described and recited herein, as discussed throughout, ambient temperature and wind directional impacts are factors for packaged units, including chillers, to be sequence ordered and implemented to render more efficient system operation. High entering air temperatures for chiller coils 250 may impose a detrimental impact on the operation of one or more packaged units 200, e.g., reduced equipment life due to excessive wear and tear operating in high entering air conditions, reduced operating capacity as a result of high entering air temperatures, reduced efficiency and increased operational energy utilization, and, if significant enough, possible loss of plant chilled water control due to chiller lockouts/alarms/diagnostics and exceeded chiller operating maximum conditions resulting in equipment shutdown and/or possible failure.

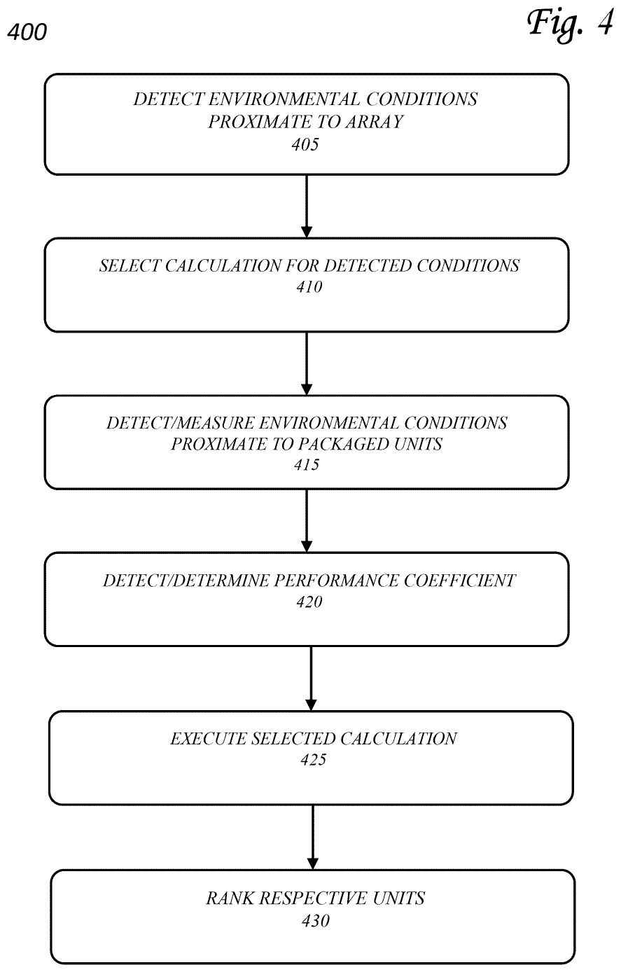

FIG. 4 is a non-limiting example of a processing flow for ordering an array of packaged units based on environmental conditions and performance, in accordance with at least some embodiments described and recited herein. As depicted, processing flow 400 includes sub-processes executed by various components of the embodiments in FIGS. 1, 2, and 3A & 3B, including at least one of packaged unit controller 220 or array controller 320, in cooperation with transducers 275 and/or 290, ambient temperature sensor 305, one or more array wind sensors 310, and entering air sensors 307 corresponding to each of packaged units 200 or applied to array controller 320. However, processing flow 400 is not limited to such components and processes, as obvious modifications may be made by re-ordering two or more of the sub-processes described here, eliminating at least one of the sub-processes, adding further sub-processes, substituting components, or even having various components assuming sub-processing roles accorded to other components in the following description.

Processing flow 400 may include various operations, functions, or actions as illustrated by one or more of blocks 405, 410, 415, 420, 425, and 430. These various operations, functions, or actions may, for example, correspond to software, program code, or program instructions executable by a digital processor that causes the functions to be performed.

As set forth above, ambient temperature relative to array 300, as determined or measured by one or more of ambient temperature sensor 305, and wind speed relative to array 300, as determined or measured by one or more of array wind sensors 310, are factors by which either of packaged unit controller 220 or array controller 320 determines which environmental- and/or performance-based metrics are, in turn, factored to determine and/or compute a staging performance coefficient.

In the embodiments described and recited herein, one non-limiting example determines which environmental- and/or performance-based metrics are, in turn, factored to determine and/or compute a staging performance coefficient based on a set point of a facility ambient temperature and a wind speed relative to array 300. As a non-limiting example, so long as the set point for the ambient temperature at or near array 300 is uniformly applied, the set point may be, e.g., 70° F., and the wind speed relative to array 300 may be 5 mph (miles per hour). The setpoint may be user-adjustable and set, e.g., between 60-70° F. for a default value to allow for formula changeover based on ambient temperature value with a deadband applied.

Thus, in an example embodiment, a centralized array controller 320 or controllers 220 respectively corresponding to each of packaged units 200 may instruct packaged units 200 to disable respective condenser air sampling when temperature sensor 305 determines ambient temperature to be less than a changeover setpoint, plus or minus the deadband. Accordingly, in low ambient temperatures, energy usage is reduced on the small amount of energy used for air sampling and a number of starts on fans is reduced, even though they would be controlled to a low-speed mode of operation when air is sampled and run for short periods of time. Further, in low ambient conditions, the need/requirement for staging optimization based on wind and entering air temperature is greatly reduced or no longer present, due to the reduced impact of potentially high entering condenser air temperatures at each operating chiller.

At block 405 (detect environmental conditions proximate to array), in accordance with at least some non-limiting example embodiments, at least one of packaged unit controller 220 or array controller 320 receives from temperature sensor 305, a current ambient temperature near and/or surrounding array 300; and at least one of packaged unit controller 220 or array controller 320 also receives, from array wind sensor 310, a current wind speed near and/or surrounding array 300 as representative of a facility wind condition.

Processing proceeds to block 410 (select calculation for detected conditions).

One example embodiment includes array controller 320, at 410, receiving from temperature sensor 305 an ambient temperature at or above the set point, e.g., 75° F., and receiving from array wind sensors 310 an ambient wind speed below, e.g., 5 mph relative to array 300. For explanatory purposes only, this will be regarded as the high-temperature, low-wind embodiment. Thus, for each packaged unit, array controller 320 calculates a performance coefficient as follows:

(ranking based on entering air temperature/speed)+(summation of rank orders of condenser performance and evaporator performance)+(rank order based on current operational time or current idle time×0.25).

Accordingly, array controller 320 is configured to determine a performance coefficient for each packaged unit 200 corresponding to array 300 based on the rank order of all packaged units 200 regarding current temperature or speed of air entering each packaged unit 200, the rank order of all packaged units 200 regarding a summation of rank orders of condenser performance and evaporator performance, and a weighted value rank order for each packaged unit 200 based on current operational time, i.e., run time, or current idle time. That is, when entering air temperature or speed and performance conditions are of greatest influence to render more efficient for each respective packaged unit 200 and the values thereof are similar, a weighted operational time or idle time may serve as a distinguishing parameter.

Further, rank sorting all values used in the calculation ensures that values will not grow over time to impact the weighting of any individual value in the equation, regardless of operational time, current idle time, or any other factor. Further, in this calculation for higher ambient conditions, operational time and current idle time are negligible factors, but potentially allow for distinguishing between packaged units in the staging order.

Another example embodiment, at block 410, includes array controller 320 receiving from temperature sensor 305 an ambient temperature at or above the set point, e.g., 70° F., and also receiving from wind sensor 310 an ambient wind speed above, e.g., 5 mph relative to array 300. For explanatory purposes only, this will be regarded as the high-temperature, high-wind embodiment. These temperatures are mere examples to illustrate the select calculation being made. Thus, for each packaged unit, array controller 320 calculates a performance coefficient as follows:

(wind compensated preferential staging order×1.5)(summation of rank orders of condenser performance and evaporator performance×0.5)+(ranking based on entering air temperature/speed×0.5)+(rank order based on current operational time or current idle time×0.025)

Accordingly, array controller 320 is configured to determine a performance coefficient for each packaged unit 200 corresponding to array 300 based on the multistate value, e.g., wind directional coefficient, created for each packaged unit 200 based on a direction of the incoming wind detected by each respective wind sensor 310, the rank order of all packaged units 200 based on a summation of rank orders of condenser performance and evaporator performance, and a weighted value rank order for each packaged unit 200 based on current operational time, e.g., run time, or current idle time.

Computational Fluid Dynamics referred to in this section as CFD, has been conducted and analyzed. The resulting data shows a significant impact to HVAC equipment environmental air temperatures in the environmental air space surrounding HVAC equipment, relative to the equipment operational state of surrounding HVAC equipment. For example, given a layout or arrangement of 20 chillers arranged in a grid, with chillers operating in a cooling mode of operation, rejected heat from equipment coils, has the potential to increase the entering air of downstream chillers, up to as much as 35 degrees F. As a result, the operating downstream chillers or HVAC equipment (e.g., 200B) is required to operate in a condition where the entering air temperature to their coils is increased as much as 35 degrees above the outdoor ambient air temperature. Operating in this state, HVAC equipment designed to reject heat from the conditioned space or medium can be negatively impacted. Likewise, in a heating mode of operation.

This negative impact to nearby HVAC equipment has the potential to adversely impact efficiency/energy utilization and total usage, capacity, equipment and system reliability, equipment and component lifespan as well as increase equipment “wear and tear” due to operating in conditions outside of normal or expected outdoor ambient air temperatures typically present at the inlet of condenser, evaporator or other free cooling or heat exchange surfaces and components.

For certain site HVAC applications such as Data Centers, the operation of HVAC equipment and its function of heat rejection is critical to site operation.

The solutions and embodiments described and/or recited herein address this potential problem using a means of optimizing or rank sorting sequence staging of said HVAC equipment, to alleviate these potentially negative impacts to HVAC systems, operation and conditioning of the controlled environment and mediums, while also considering the concern for equalized runtime or run hours for the controlled HVAC equipment.

Yet another example embodiment of block 410 includes array controller 320 receiving from wind sensor 305 an ambient temperature below the set point, e.g., 75° F., thus rendering the wind speed received from wind sensor 310 a non-factor. For explanatory purposes only, this will be regarded as the low-temperature embodiment. Thus, for each packaged unit, array controller 320 calculates a performance coefficient as follows:

(ranking based on entering air temperature/speed)+(summation of rank orders of condenser performance and evaporator performance)+(rank order based on current operational time or current idle time×2).

Accordingly, array controller 320 is configured to determine a performance coefficient for each packaged unit 200 corresponding to array 300 based on the rank order of all packaged units 200 based on the current temperature or speed of the air entering each packaged unit 200, the rank order of all packaged units 200 based on a summation of rank orders of condenser performance and evaporator performance, and a weighted value rank order for each packaged unit 200 based on current operational time, e.g., run time, or current idle time. That is, when the ambient temperature in or around array 300 is cooler, ordering or staging of the respective packaged units 200 may be adjusted to allow for more equalized operational time or idle time. In higher ambient conditions, wind, entering air and approach, are weighted heavier in the resulting calculations.

When the calculation for detected conditions at or near array 300 is selected at block 410, processing may proceed to block 415 (detect environmental conditions proximate to packaged units) and block 420 (execute selected calculation).

Because array controller 320 may be monitoring all sensors and components of the respective packaged units, it is understood that array controller 320, for execution of the sub-processes at blocks 415 and 420, array controller 320 is further designed, programmed, or configured to:
to receive from each entering air sensor 307, of which each of the respective packaged units 200 has at least one, a current temperature and/or speed of air entering the respective packaged unit 200; and to rank order all packaged units 220 corresponding to array 300 based on the current temperature or speed of the air entering each packaged unit 220. With X being the number of packaged units 200 in array 300, array controller 320 rank orders the packaged units from 1 to X, with 1 corresponding to the packaged unit 200 having the lowest current temperature, and X corresponding to the packaged unit 200 having the highest current temperature;
determine a performance ranking of the condenser 240 for each packaged unit 200 based on, in part, a known or predetermined refrigerant pressure temperature curve for packaged unit 200, indicative of optimal performance. Thus, at least one of packaged unit controller 220 or array controller 320 receives from transducer 290 a detected refrigerant temperature and also receives from ambient temperature sensor 305 an ambient temperature, the difference is measured against a known curve to gauge performance of the respective packaged unit. A disparity between refrigerant temperature and ambient temperature of a predetermined threshold level, e.g., 40° F., may be indicative of coils 250 that are underperforming due to, e.g., dirt, rust, age, and the like, etc., thus causing array controller 320 to assign a high-performance coefficient for the respective packaged unit 200. Performance of condenser 240 of the respective packaged units 200 is ranked accordingly;
determine a performance ranking of the evaporator 180 for each packaged unit based on, in part, a difference between a saturated temperature of evaporator 180 as vapor evaporates before being pulled back to compressor 120 as well as a temperature of water as it exits the evaporator, as determined by a transducer 290 and received by array controller 320. A disparity between a saturated temperature of evaporator 180 and a temperature of water as it exits therefrom of greater than, e.g., 5° F., based on a known curve may also be indicative of coils 230 or other heat exchanger components that are underperforming due to, e.g., dirt, rust, age, and the like, etc., thus causing array controller 320 to assign a high-performance coefficient for the respective packaged unit 200. Performance of evaporator 180 of the respective packaged units 200 is ranked accordingly;
rank sort each of the packaged unit 200 corresponding to a common array 300 based on a summation of the performance rankings of the respective condensers 140 and evaporators 180 corresponding to each of the packaged units 200. This summation value is utilized to determine an overall performance coefficient, as described further below, by which stage ordering of the packaged units is implemented;
determine and/or record a current operational time, current idle time, and/or past operational times, e.g., run time, for each of packaged units 200; and then rank order each of the packaged units 200 corresponding to a common array 300 based on the current and/or recorded operational time for each packaged unit 200. In accordance with at least some of the embodiments described and/or recited herein, with X being the number of packaged units 200 in the common array 300, array controller 320 rank orders the packaged units from 1 to X, with 1 corresponding to the packaged unit 200 having the lowest current operational time or having the longest current idle time, and X corresponding to the packaged unit 200 having the highest current run time or having the shortest current idle time; and
receive, from each of wind sensors 310, a current wind speed and direction near and/or surrounding array 300; and then, for each of packaged units 200, divide the overall possible wind direction into degrees of azimuth using 0-360 for the overall range. The overall span of azimuth may then be divided into eight (8) sections representing one of the following directions indicated in Table 1, above, with degrees of azimuth defined for each of the ranges, and create and assign a multistate value, i.e., wind directional coefficient, representing the eight (8) possible directional states and ranges.

When the environmental conditions proximate to the packaged units are detected and/or measured at block 415 and the performance coefficients are detected and/or determined at block 420, processing may proceed to block 425 (execute selected calculation).

For execution of the sub-process at block 425, array controller 320 is designed, programmed, or otherwise configured to perform the selected calculations as follows:
for the high-temperature, low-wind embodiment:

(ranking based on entering air temperature/speed)+(summation of rank orders of condenser performance and evaporator performance)+(rank order based on current operational time or current idle time×0.25);
for the high-temperature, high-wind embodiment:

(wind compensated preferential staging order×1.5)+(summation of rank orders of condenser performance and evaporator performance×0.5)+(ranking based on entering air temperature/speed×0.5)+(rank order based on current operational time or current idle time×0.025); and
for the low-temperature embodiment. Thus, for each packaged unit, controller 220 calculates a performance coefficient as follows:

(ranking based on entering air temperature/speed)+(summation of rank orders of condenser performance and evaporator performance)+(rank order based on current operational time or current idle time×2).

When the calculations are performed for each packaged unit 200 at block 425, processing may proceed to block 430 (rank respective units).

For execution of the sub-process at block 430, array controller 320 is designed, programmed, or otherwise configured to rank the respective packaged units 200 corresponding to array 300 based on the results of the calculations from 1 to X, with 1 corresponding to the packaged unit 200 having the lowest calculated value, and X corresponding to the packaged unit 200 having the highest calculated value. The ranking is implemented accordingly since a lower calculated value is indicative of a more efficiently operating packaged unit.

At least some example embodiments of ordering a chiller system include array controller 320 exploiting the ranking to then facilitate ordering or staging of operation accordingly. Other non-limiting example embodiments include array controller 320 transmitting or otherwise sharing the ranking with another hardware or software controller, e.g., application, to thereby order or stage operation of the packaged units.

FIG. 5 shows an illustrative computing embodiment, in which the processes for ordering of a chiller system based on environmental conditions and performance coefficients may be executed.

In accordance with at least some non-limiting example embodiments, array controller 320 may be implemented as a processor or processing device having a network element and/or any other device corresponding thereto, particularly as applicable to the applications and/or programs described above corresponding to at least one of packaged unit controller 320 or array controller 320, relative to the embodiments of FIGS. 1-3B.

In a very basic configuration, array controller 320 may typically include, at least, one or more processors 502, memory 504, one or more input components 506, and one or more output components 508.

Processor 502 may refer to, e.g., a microprocessor, a microcontroller, a digital signal processor, or any combination thereof.

Memory 504 may refer to, e.g., a volatile memory, non-volatile memory, or any combination thereof, and may store, program data to perform the functions for which controller 220 is designed, programmed, or otherwise configured, as described and even contemplated in the preceding description.

Memory 504 may store executable instructions to implement any of the functions or operations described above and, therefore, memory 504 may be regarded as a computer-readable medium.

Input component 506 may refer to a built-in component or module to receive input from any and all of transducers 275 and 290, and sensors 305, 307, 310, and 310.

Output component 508 may refer to a built-in component or module to output controlling instructions.

Display component 510 may refer to, e.g., a solid state display that may have touch input capabilities. That is, display component 510 may include capabilities that may be shared with or replace those of input component 506.

Computer-readable medium 512 may refer to a separable machine-readable medium that is configured to store one or more programs that embody any of the functions or operations described above. That is, computer-readable medium 512, which may be received into or otherwise connected to a drive component of controller 220/320, may store executable instructions to implement any of the functions or operations described above. These instructions may be complimentary or otherwise independent of those stored by memory 504.

Transceiver 514 may refer to a network communication link for controller 220/320, configured as a wired network or direct-wired connection. Alternatively, transceiver 514 may be configured as a wireless connection, e.g., radio frequency (RF), infrared, Bluetooth®, and other wireless protocols.

### ASPECTS

In the following, any one or more of the Aspects may be combined with each other.

Aspect 1. A computer-readable medium having executable instructions that, when executed, cause one or more processors to control respective packaged units in an array thereof, the instructions comprising:
detecting environmental conditions proximate to the array;
selecting a calculation for ordering the packaged units based on at least one of the detected environmental conditions;
detecting environmental conditions proximate to each respective packaged unit in the array;
executing the selected calculation for each of the packaged units included in the array; and
ranking the respective packaged units based on respective results of the executed calculation,
   wherein the selected calculation for each of the respective packaged units factors an operational coefficient, a weighted value of a detected runtime, and at least one of a detected intake air temperature or a detected wind speed.

Aspect 2. The computer-readable medium according to Aspect 1, wherein the detected environmental conditions proximate to the array include temperature and wind speed.

Aspect 3. The computer-readable medium according to Aspect 1 or Aspect 2, wherein the selected calculation includes a ranking of evaporator and condenser performance for the respective packaged unit relative to all others of the packaged units within the array.

Aspect 4. The computer-readable medium according to any of Aspects 1 to 3, wherein the selected calculation includes adding together a ranking of the detected air temperature for the respective packaged unit relative to all others of the packaged units within the array, the ranking of evaporator and condenser performance for the respective packaged unit relative to all others of the packaged units within the array, and a weighted value of the detected runtime for the respective packaged unit.

Aspect 5. The computer-readable medium according to any of Aspects 1 to 3, wherein the selected calculation includes adding together a ranking of the detected air temperature for the respective packaged unit relative to all others of the packaged units within the array, the ranking of evaporator and condenser performance for the respective packaged unit relative to all others of the packaged units within the array, and a weighted value of the detected runtime for the respective packaged unit.

Aspect 6. A controller method of operating an array of packaged units corresponding to a heating, ventilation, air conditioning, and refrigeration (HVACR) system, comprising:
detecting at least two current environmental conditions for the array of packaged units;
determining a calculation to be used to order the packaged units, respectively, relative to one another based on the determined current environmental conditions;
detecting an air temperature at each of the respective packaged units;
detecting at least a wind speed at or near the array;
detecting a runtime for each of the respective packaged units; and
calculating, using the determined calculation, an operational coefficient for each of the respective packaged units based on, for each of the respective packaged units, a weighted value of the detected runtime and at least one of the detected air temperature or detected wind speed.

Aspect 7. The controller method of Aspect 6, wherein the at least two current environmental conditions for the array of packaged units includes temperature and wind speed.

Aspect 8. The controller method of Aspect 6 or Aspect 7, wherein the determined calculation includes a ranking of evaporator and condenser performance for the respective packaged unit relative to all others of the packaged units within the array.

Aspect 9. The controller method of any of Aspects 6 to 8, wherein the temperature is above a predetermined threshold temperature level and the wind speed is within a negligible range.

Aspect 10. The controller method of any of Aspects 6 to 9, wherein the determined calculation includes adding together a ranking of the detected air temperature for the respective packaged unit relative to all others of the packaged units within the array, a ranking of evaporator and condenser performance for the respective packaged unit relative to all others of the packaged units within the array, and a weighted value of the detected runtime for the respective packaged unit.

Aspect 11. The controller method of any of Aspects 6 to 10, wherein the method further comprises staging the array of packaged units in a sequence of the calculated operational coefficients for each of the packaged units.

Aspect 12. The controller method of any of Aspects 6 to 7, wherein the temperature is below a predetermined threshold temperature level.

Aspect 13. The controller method of any of Aspects 6 to 8 and 12, wherein the determined calculation includes calculating a ranking of the detected air temperature for the respective packaged unit relative to all others of the packaged units within the array, a ranking of evaporator and condenser performance for the respective packaged unit relative to all others of the packaged units within the array, and a weighted value of the detected runtime for the respective packaged unit.

Aspect 14. The controller method of any of Aspects 6 to 13, wherein the method further comprises staging the array of packaged units in a sequence of the calculated operational coefficients for each of the packaged units.

Aspect 15. The controller method of any of Aspects 6 to 14, wherein the detected winds peed for each of the packaged units is weighted by degrees azimuth relative to an intake orientation for the respective packaged unit.

Aspect 16. The controller method of any of Aspects 6 to 15, wherein the determined calculation includes a summation of a ranking of the weighted value of the detected wind speed for the respective packaged unit relative to all others of the packaged units within the array, a ranking of evaporator and condenser performance for the respective packaged unit relative to all others of the packaged units within the array, and a weighted value of the detected runtime for the respective packaged unit.

Aspect 17. The controller method of any of Aspects 6 to 16, wherein the method further comprises staging the array of packaged units in a sequence of the calculated operational coefficients for each of the packaged units.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

We claim:

1. A computer-readable medium having executable instructions that, when executed, cause one or more processors to control respective packaged units from an array thereof, the instructions comprising:
detecting environmental conditions proximate to the array;
selecting a calculation for ordering the packaged units based on at least one of the detected environmental conditions;
executing the selected calculation for each of the packaged units included in the array; and
ranking the respective packaged units based on respective results of the executed calculation,
wherein the selected calculation for each of the respective packaged units factors an operational coefficient, a weighted value of a detected runtime, and at least one of a detected intake air temperature or a detected wind speed.

2. The computer-readable medium according to claim 1, wherein the detected environmental conditions proximate to the array include temperature and wind speed.

3. The computer-readable medium according to claim 1, wherein the selected calculation includes a ranking of evaporator and condenser performance for the respective packaged unit relative to all others of the packaged units within the array.

4. The computer-readable medium according to claim 3, wherein the selected calculation includes adding together a ranking of the detected air temperature for the respective packaged unit relative to all others of the packaged units within the array, the ranking of evaporator and condenser performance for the respective packaged unit relative to all others of the packaged units within the array, and a weighted value of the detected runtime for the respective packaged unit.

5. The computer-readable medium according to claim 3, wherein the selected calculation includes adding together a ranking of the detected air temperature for the respective packaged unit relative to all others of the packaged units within the array, the ranking of evaporator and condenser performance for the respective packaged unit relative to all others of the packaged units within the array, and a weighted value of the detected runtime for the respective packaged unit.

6. A controller method of operating an array of packaged units corresponding to a heating, ventilation, air conditioning, and refrigeration (HVACR) system, comprising:
detecting at least two current environmental conditions for the array of packaged units;
determining a calculation to be used to order the packaged units, respectively, relative to one another based on the determined current environmental conditions;
detecting an air temperature at each of the respective packaged units;
detecting at least a wind speed at or near the array;
detecting a runtime for each of the respective packaged units; and
calculating, using the determined calculation, an operational coefficient for each of the respective packaged units based on, for each of the respective packaged units, a weighted value of the detected runtime and at least one of the detected air temperature or detected wind speed.

7. The controller method of claim 6, wherein the at least two current environmental conditions for the array of packaged units includes temperature and wind speed.

8. The controller method of claim 6, wherein the determined calculation includes a ranking of evaporator and condenser performance for the respective packaged unit relative to all others of the packaged units within the array.

9. The controller method of claim 7, wherein the temperature is above a predetermined threshold temperature level and the wind speed is within a negligible range.

10. The controller method of claim 9, wherein the determined calculation includes adding together a ranking of the detected air temperature for the respective packaged unit relative to all others of the packaged units within the array, a ranking of evaporator and condenser performance for the respective packaged unit relative to all others of the packaged units within the array, and a weighted value of the detected runtime for the respective packaged unit.

11. The controller method of claim 10, wherein the method further comprises staging the array of packaged units in a sequence of the calculated operational coefficients for each of the packaged units.

12. The controller method of claim 7, wherein the temperature is below a predetermined threshold temperature level.

13. The controller method of claim 12, wherein the determined calculation includes adding together a ranking of the detected air temperature for the respective packaged unit relative to all others of the packaged units within the array, a ranking of evaporator and condenser performance for the respective packaged unit relative to all others of the packaged units within the array, and a weighted value of the detected runtime for the respective packaged unit.

14. The controller method of claim 13, wherein the method further comprises staging the array of packaged units in a sequence of the calculated operational coefficients for each of the packaged units.

15. The controller method of claim 6, wherein the detected wind speed for each of the packaged units is weighted by degrees azimuth relative to an intake orientation for the respective packaged unit.

16. The controller method of claim 15, wherein the determined calculation includes a summation of a ranking of the weighted value of the detected wind speed for the respective packaged unit relative to all others of the packaged units within the array, a ranking of evaporator and condenser performance for the respective packaged unit relative to all others of the packaged units within the array, and a weighted value of the detected runtime for the respective packaged unit.

17. The controller method of claim 16, wherein the method further comprises staging the array of packaged units in a sequence of the calculated operational coefficients for each of the packaged units.
